(19) United States
(12) Patent Application Publication
(10) Pub. No.: US 2005/0024899 A1
(43) Pub. Date: Feb. 3, 2005

(54) Flyback type alternation power supply with primary/secondary synchronize control

(75) Inventor: Hui Chang Yang, Taipei Hsien (TW)

Correspondence Address: BROWDY AND NEIMARK, P.L.L.C.;624 NINTH STREET, NW, SUITE 300, WASHINGTON, DC, 20001-5303, US

(73) Assignee: NIKO SEMICONDUCTOR CO., LTD, Taipei (TW)

(21) Appl. No.: 10/627,756

(22) Filed: Jul. 28, 2003

(51) Int. Cl. H02M 3/335

(52) U.S. Cl. 363/21.15

(57) ABSTRACT

A flyback type alternation power supply includes a voltage transformer, a primary switching unit, a secondary switching unit and an insulating unit. Wherein, the primary switching unit consists of at least a first switching component and a first control circuit. Further, the secondary switching unit consists of at least a second switching component and a second control circuit. The first control circuit controls the insulating unit to output a cut-off signal to the second control circuit. After receiving the cut-off signal, the second control circuit commands the second switching component to enter a cut-off state. By doing this, the first control circuit could control time of sending cut-off signal to the second switching component. Hence, the second switching unit could enter cut-off state before or at the time when secondary current descent to zero, and allow the present invention to operate in continuous or non-continuous mode.

### FIELD OF THE INVENTION

The present invention relates to a flyback type alternation power supply with primary/secondary synchronize control; specially relates to a power supply that turns on and off by using a switching component.

### BACKGROUND OF THE INVENTION

As shown in FIG. 1A: the circuit diagram of general flyback type alternation power supply. Wherein, the switching component S1 could be a transistor, thyristor or MOSFET that controls on/off function with small signals. The component D1 has uncertain voltage drop within 0.4˜1.5V when it is conducting (characteristics of diode). Therefore, the events such as low efficiency or diode needing large area of heat dissipating fan due to over consumption of power when outputting voltage Vo is low. For example, when Vo is 5V dc, voltage drop of D1 is 0.4V with D1 reverse voltage 30V dc and outputting power of power supply is 50 W (5V/10 A); then the power consumption on D1 is 0.4*10 A=4 W. By neglecting power losses of other components, the efficiency of this power supply is 50 W/(50 W+4 W)=96%.

In other case as shown in FIG. 1B: the circuit diagram of a prior art flyback type alternation power supply. In order to rise the efficiency of flyback type alternation power supply, the D1 component is replaced with S2 (transistor, thyristor or MOSFET). With current technology on MOSFET, such as SI4410, the RDS (on) can be lowered to 10 mΩ for reducing power consumption to overcome the above-mentioned drawback. If we use the above example for comparison and replacing Vo to 5V dc, S2 to SI4410 (RDS=11 mΩ, V DS=30V) and output power is 50 W (5V/10 A); then voltage drop across S2 is 10 A*11 mΩ=110 mV dc. The power consumption of S2 is now 110 mV*10 A=1100 mW=1.1 W. Without including power consumption of other component, the efficiency is now 50 W/(50 W+1.1 W)=97.8, which is raised 6.2% in compare to use of diode. Although this is the goal of Engineers, but the process of replacing D1 to S2 still meets technical bottleneck.

The FIG. 2 shows the voltage and current waveform of flyback transformer in prior-art. S2 must be accurately controlled to conduct after occurrence of t1 and cut-off before arrives of t2. Generally speaking, t1a is easier to control because t1 is the time when VN2 switching from negative to positive. We could use VN2 as a trigger signal (after some set delay time) to conduct S2. However, the occurrence of flyback transformer t2 changes along with the variation of load (I0) and it is difficult to predict. Further, t2a must cut-off S2 before arrival of t2; otherwise, Co will charge N2 through S2 and generate a reverse current (−IS1) when S1 is again conducted, which can result in damage of S1.

Therefore, when flyback type alternation power supply uses the switching component to control its secondary side rectification circuit (in transformer), normally the switching component in secondary side is used to control its conduct/cut-off state whereas the primary side is normally controlled passively. In other words, flyback type alternation power supply commands the switching component in secondary side to cut-off and then command the switching component in primary side to conduct. For example, a current transformer detects secondary current on the instant it reaches zero point; the switching component at the secondary side is commanded to cut-off. Then the primary side switching component is conducted by using remain field of the transformer to produce electromotive force. However, this technology is usually applied on non-continuous mode (secondary switching component cut-off when secondary current reaches zero, and then conduct switching component on the primary side).

The previous described method on flyback type alternation power supply using switching component at the secondary side as active and switching component on the primary side as passive can only operate the power supply on non-continuous mode. The result is a larger volume of transformer and less efficiency of power supply. If we can make flyback type alternation power supply to function in continuous mode, then we have the advantages on smaller volume of transformer and higher efficiency of power supply. The continuous mode means that the switching component at the primary side is conducted while the current on the secondary side is still higher than zero point and enters cut-off mode.

Furthermore, the previously mentioned current transformer on detecting variation of secondary current could cancel the effect of using switching component instead of diode. Because current transformer blocks direct current and therefore circuits must be added to recover the DC level. This manner will largely affect the accuracy of current transformer when it is used to detect current level. The concern is that the accuracy of the current transformer is vitally important on detection; otherwise, the alternating power supply will either easily burned down or raise less possible efficiency.

Therefore, we can see from the above described prior-art on flyback type alternation power supply, which has some inconvenience and disadvantages on practical application that can be further improved.

### SUMMARY OF THE INVENTION

The main purpose of the present invention is to provide a primary/secondary synchronize control on flyback type alternation power supply, which relates to the prior-art of flyback type alternation power supply with using switching component to control transformer output. The switching component consumes very low power and hence it effectively raises the efficiency of the power supply. However, for the best performance of flyback type alternation power supply the switching component must be controlled accurately on the conduction and cut-off timing. There has been mentioned in the prior-art about how to effectively control the conduction time using switching component. Nevertheless, there are still many difficulties to overcome in controlling of cut-off time using switching component. Therefore, the present invention aims to provide a control to make power supply raises its efficiency with the use of switching component by controlling its cut-off time.

To achieve the above goal, the present invention further provides a flyback type alternation power supply with primary/secondary synchronize control, which consists of a transformer, a primary switching unit, a secondary switching unit, and a insulation unit. Wherein, the primary switching unit is constituted by a first switching component and a first control circuit; the first switching component connects to the primary side of the transformer and its conduction state is controlled by the first control circuit. Further, the secondary switching unit consists at least a second switching component, which connects to the secondary side of transformer. The mentioned insulation unit is connected in between the first control circuit and the second switching component, wherein the first control circuit controls the insulation unit for outputting a cut-off signal to command the second switching component to enter the cut-off state.

To achieve the above goal, the present invention further provides a flyback type alternation power supply with primary/secondary synchronize control, which consists of a transformer, a primary switching unit, a secondary switching unit, and a insulation unit. Wherein, the primary switching unit is constituted by a first switching component and a first control circuit; the first switching component connects to the primary side of the transformer and its conduction state is controlled by the first control circuit. Further, the secondary switching unit consists at least a second switching component, which connects to the secondary side of transformer, and a second control circuit, which controls the conductions state of the second switching component. The mentioned insulation unit connects in between the first control circuit and the second control circuit; wherein the first control circuit controls the insulation unit for outputting a cut-off signal to the second control circuit, which then command the second switching component to enter a cut-off state.

Additional objects and advantages of the invention will be set forth in description which follows, and in part will be obvious from the description, or may be learned by practice of the invention. The objects and advantages of the invention may be realized and obtained by means of the instrumentalities and combinations particularly pointed out in the appended claims.

### BRIEF DESCRIPTION OF THE DRAWINGS

FIG. 1A: the circuit diagram of general flyback type alternation power supply;

FIG. 1B: the circuit diagram of present flyback type alternation power supply;

FIG. 2: the voltage and current waveforms of the FIG. 1B;

FIG. 3: the block circuit diagram of the first preferred embodiment in the present invention;

FIG. 4: the circuit diagram of the second preferred embodiment in the present invention;

FIG. 5: the waveforms of the FIG. 4;

FIG. 6: the circuit diagram of third embodiment in the present invention;

FIG. 7: the waveforms of the FIG. 6.

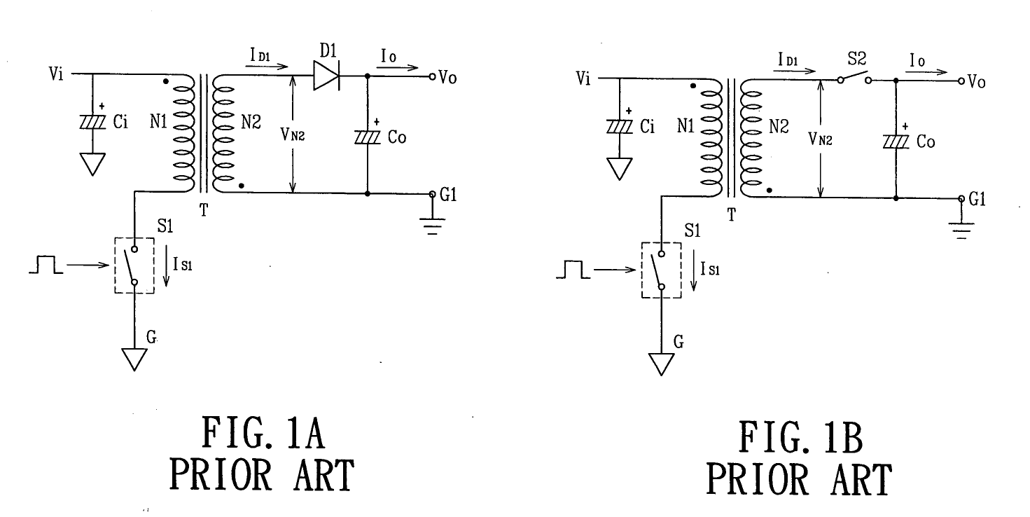

### DETAIL DESCRIPTIONS OF THE PREFERRED EMBODIMENTS

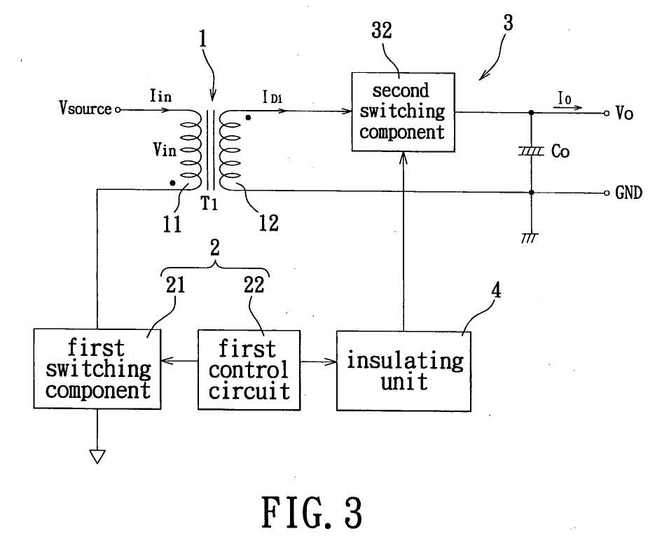

Please refer to FIG. 3 the block circuit diagram of the preferred embodiment in the present invention. The present invention is a flyback type alternation power supply with primary/secondary synchronize control, which consists of a transformer 1, a primary switching unit 2, a secondary switching unit 3 and an insulation unit 4. Wherein, the transformer 1 has a primary side 11 and a secondary side 12. The primary switching unit 2 connects to the primary side 11 and secondary switching unit 3 is connected to secondary side 12. The duty of transformer 1 in the flyback type alternation power supply is mainly to transfer energy from primary side 11 to secondary side 12. There are positive/negative reverse voltages and its relative currents at the output ends of primary side 11 and secondary side 12.

The primary switching unit 2 is connected to an electric supply source Vsource for generating high frequency signal Vin and primary electric current Iin. Wherein, the primary switching unit 2 is constituted by a first switching component 21, which is joined to primary side 11 of the transformer 1, and a first control circuit 22. The first control circuit 22 is used to control the conducting/cut-off states of the first switching component 21. In this way, the switching state operation of transformer 1 can be mastered. Moreover, the first switching component 21, which is controlled with small signals, is MOSFET (Metal Oxide Semi-conductor Field Effect Transistor) or thyrister.

The secondary switching unit 3 is formed by the connection of a second switching component 32 and primary side of transformer 12. The output capacitor Co is connected to the output end of the second switching component 32 and outputting a voltage Vo. Wherein, the second switching component 32 controls the output of secondary current ID base on the switching state of transformer 1. Moreover, the second switching component 32, which is controlled by small signals, is MOSFET (Metal Oxide Semi-conductor Field Effect Transistor) or thyrister.

The insulating unit 4 is connected to first control circuit 22 and second switching component 32. It is used to output a cut-ff signal to the second switching component 32 for entering cut-off state.

The main operating principle in this preferred embodiment of the present invention will now be described in the following article. Firstly, assume the first switching component 21 at the primary side 11 is in cut-off state and the second switching component 32 at the secondary side 12 is in a conducting state. At this time, the secondary current ID1 has a reverse triangular wave pattern, which depicts the gradual changes of secondary current ID1 from large to small. Although one of the main functions of the first control circuit 22 is to control the conducting time of the first switching component 21. However, the most important duty is actually to send out a cut-off signal to the second switching component 32 via insulating unit 4 before first switching component 21 conducts. In this way, at the time when transformer 1 has switching state variation after first switching component 21 has conducted, the drawback situation of simultaneous conduction of both primary and secondary switching components can be avoided. Further, the first control circuit 22 could control time of sending cut-off signal to second switching component 32 and make second switching component 32 to enter cut-off state before or at the time secondary current ID1 descends to zero. Hence, it allows this preferred embodiment of the present invention can be able to operate in continuous or non-continuous mode. Wherein, the length of conduction time of the first switching component 21 is also controlled by first control circuit 22. When first switching component 21 cut-off, the transformer changes its switching state and secondary will again shows the above mentioned reversed triangular wave pattern.

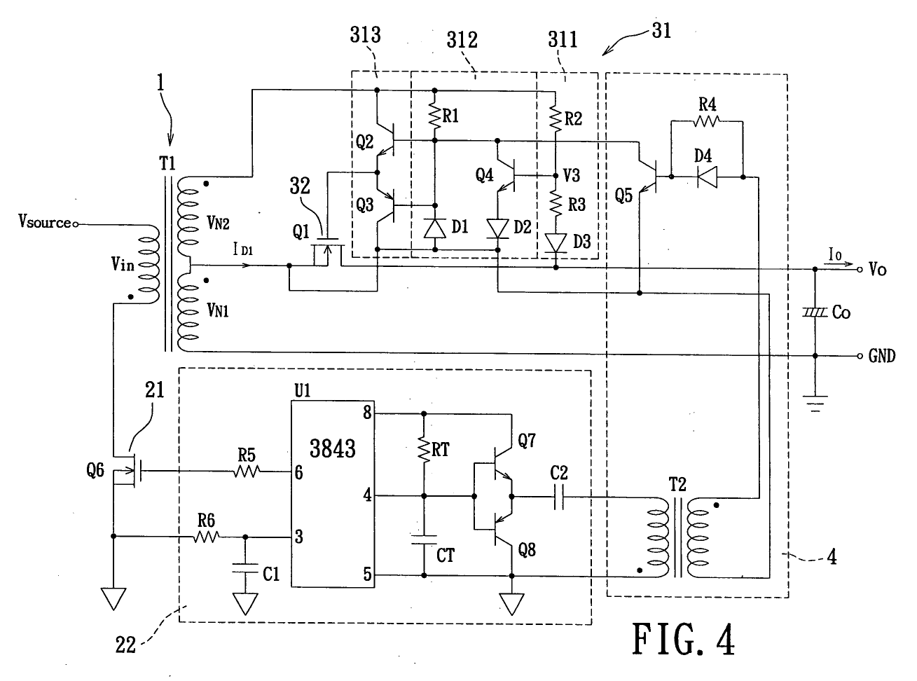

Please refer to FIG. 4: the circuit diagram of the second preferred embodiment in the present invention. Wherein, the first switching component 21 is P type-MOSFET (Metal Oxide Semi-conductor Field Effect Transistor) Q6. The first control circuit 22 consists of a plus-width modulation control IC (number 3843 or 3842) U1, capacitors (C1, C2, CT), resistors (R5, R6, RT), and transistors (Q7, Q8). The insulating unit 4 is constituted by transformer T2, resistor R4, diode D4 and transistor Q5. Moreover, the second switching component 32 is N type MOSFET (Metal Oxide Semi-conductor Field Effect Transistor) Q1. One important feature, which is added to this preferred embodiment, is the second control circuit 31 for controlling cut-off state of the second switching component 32 and receiving cut-off signal from insulating unit 4.

The above-mentioned second control circuit 31 is constituted by a voltage level/divider circuit 311, driver circuit 312 and buffer circuit 313. Wherein, the voltage level/divider circuit 311 provides a voltage preference level; buffer circuit 313 outputs a voltage for controlling resistance variation in second switching component. The driver circuit 312 adjusts the output voltage of buffer circuit 313 bases on voltage preference level and enables a voltage-drop that is generated by a current flowing through the second switching component 32 to remain at a fix value. Further, the driver circuit 312 also allows resistance of second switching component 32 could vary inversely proportionally along with the output current from the transformer 1.

The operating principle of second control circuit 31 will now be described first. In the control circuit 31, the secondary current ID1 is assumed in reverse triangular wave-shape pattern and diode D1, D2 and D3 provides current insulation effect. For convenience of description, the voltage-drop across diode D1, D2 and D3 are neglected in the following article. Some assumptions are also made; such as suppose conducting resistance of Q1 is 15 mΩ, Vbe voltage of Q4 is 0.6V, V3 is set to 6.15V

Wherein, another circuit, which is in parallel connection with V3 point, is the serial connection of b-e in Q4 and s-d in Q1. Therefore, the voltage-drop on S-D ends of Q1 shall not be more than 0.15V if Q4 conduction is desired; hence, Vbe voltage of Q4 is 0.6V

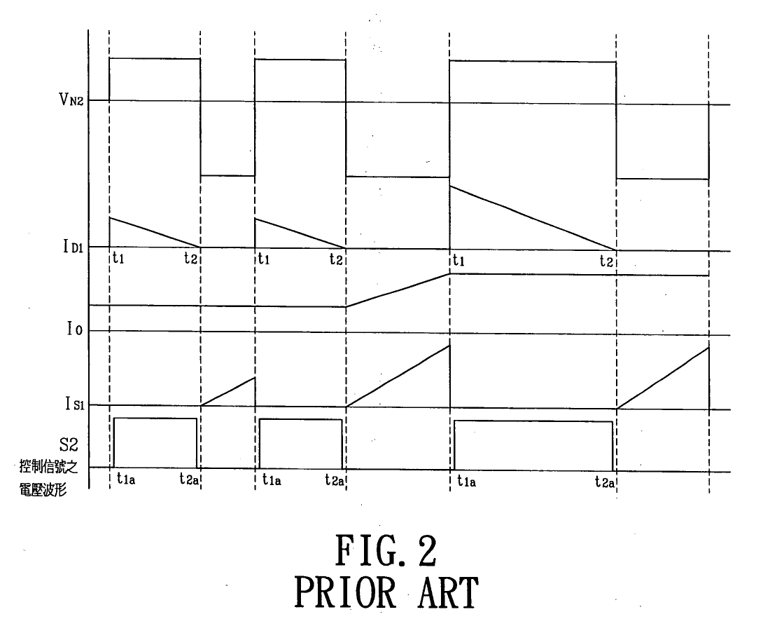

Whenever the current output ID1 from transformer 1 is varying in shape as shown in FIG. 2; if current ID1 is larger than 1 A then Q4 cuts off and Vgs makes Q1 conducts at full speed. If ID1 is smaller than 1 A, then Q4 will conduct and make the voltage drop over s-d ends of Q1 to remain at 0.15V. When current ID1 is zero, resistance of Q1 will be infinite large and makes Q1 to automatically enter cut-off state.

In other words, the main function of the second control circuit 31 in this embodiment is to let resistance of second switching circuit 32 to vary along with output secondary current ID1 and present an inverse proportional waveform. Hence, when secondary current ID1 drops to zero the resistance of second switching circuit 32 will enter cut-off state due to Q1 resistance becomes infinitely large.

However, in the second control circuit 31 in the above describing article, the Q1 would only cut-off at the time when secondary current ID1 reaches zero value. In other words, flyback power supply is operating under non-continuous mode at this time. If one wish to make flyback type alternation power supply to work in continuous mode, then first control circuit 22 must send out cut-off control signal to second switching component 32.

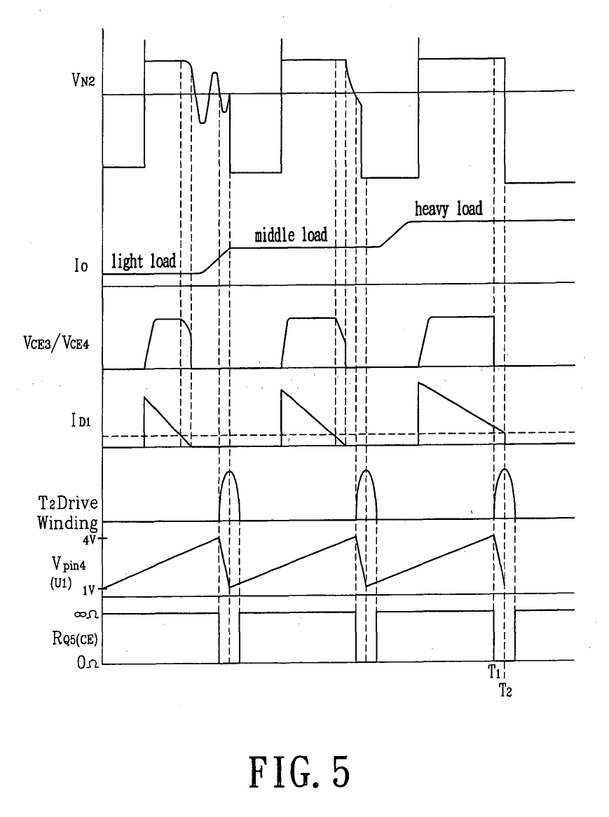

The operation of continuous mode of the embodiment is described as following; please refer to waveforms in FIG. 5. Similarly, we assume secondary current ID 1 has a reverse triangular waveform, first switching component 21 is in cut-off state and second component 32 is in conducting state. The control IC U 1 controls conduction state (conducting or cut-off) of the first switching component 21 through its pin 6. Further, pin 4 of the control IC U1 outputs a saw tooth shape waveform for driving a buffer, which constitutes transistors Q7 and Q8. The butter further sends out signal to drive switching state variation of transformer T2. Moreover, frequency of mentioned saw tooth shape waveform can be adjusted by resistor RT and capacitor CT.

As shown in FIG. 5, at the time T1 the voltage at the pin 4 of control IC U1 starts to descend from 4V towards 1V and causes changes in switching state on secondary side of transformer T2. The transistor Q5 then enters conducting state from cut-off state. The voltage level of Vce3 and Vce4 transistor fall from high level to zero and causes resistance in Q1 to approach infinity for entering cut-off state. Hence, the secondary current ID1 at the time T2 will descend to zero ampere and pin 6 of control IC U1 sends out a signal for driving first switching component 21 to conduct. Further, before secondary current ID1 descends to zero, it forces the second switching component 32 to enter cut-off state at time T2 due to voltage level of transistors Vce3 and Vce4 has dropped to zero level at time T1. Therefore, the flyback type alternation power supply could now be operated in continuous mode.

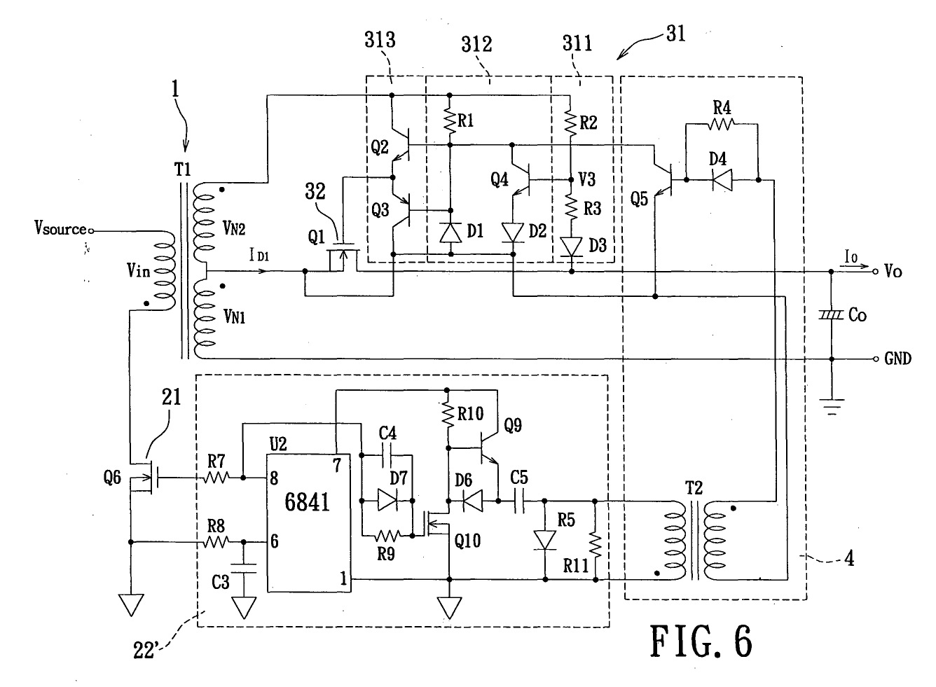

Please refer to FIG. 6: the circuit diagram of third embodiment in the present invention. Wherein, the control circuit 22 is constituted a by pulse-width modulation IC U2 (number 6841), capacitors (C3, C4, C5), resistors (R7, R8, R9, R10, R11), diodes (D5, D6, D7), and transistors (Q9, Q10).

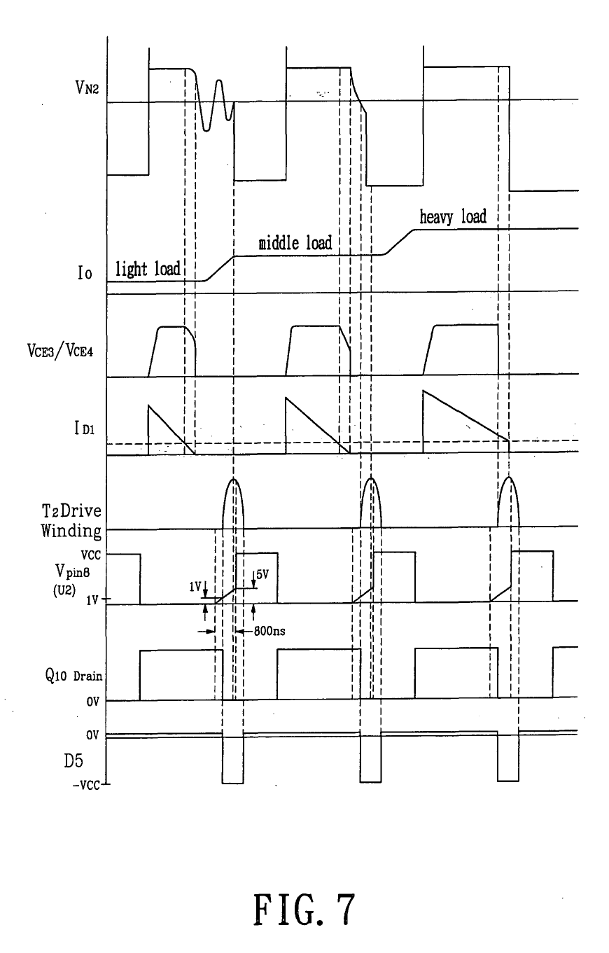

As shown is FIG. 7, pin 8 of control IC U2 is an output controlling pin. Its voltage output does not immediately rise to Vcc, but rise along a slope from 0V to 5V then straight up to Vcc voltage. Therefore, Q6 starts to conduct when output voltage at pin 8 of IC U2 reaches 5V. This embodiment uses the period that pin 8 rises from 0V to 5V (about 800 ns) before the transistor Q6 conducts to obtain synchronize pulse-wave signal for shutting downing transistor Q1. In this way, the situation of simultaneous conduction of Q1 and Q6 will be avoided.

When pin 8 of control IC U2 outputs 0V voltage, transistor Q10 does not conduct but transistor Q9 does, and capacitor C5 is charging. Because diode D5 is conducted and therefore the primary side of transformer T2 has a voltage of 0.6V The secondary side of transformer has low voltage (zero) and transistor Q5 is switched off.

The next situation is when voltage at pin 8 of control IC U2 rises from 0V to 1V; at this time, transistor Q10 is conducted (Q10 must kind of FET that can be conducted at 1V). However, at this point in time the transistor Q6 has not yet conducted and due to the conduction of transistor Q10, the transistor Q9 is switched off and capacitor C5 will discharge. Because of discharging on capacitor C5, the primary side of transformer T2 will generate a negative Vcc wave pulse (−Vcc). Further, because of the reverse polar property at two sides of transformer, the secondary side of transformer T2 hence has positive wave signal for driving transistor to conduction. The conduction of transistor Q5 leads to the turn-off of transistor Q 1. The transistor Q6 will start to conduct when the output voltage at pin 8 of control IC U2 rises to about 5V Until the pin 8 voltage of control IC U2 again drops from high (5V) to low (0V) voltage, then the transistor Q6 will switch off and transistor Q1 conducts.

According to the above article, by controlling the time of outputting cut-off signal from insulating unit 4 to second switching component 32 using first control circuit 22, the present invention can hence perform in continuous and non-continuous mode. Furthermore, it also ensures that both first switching component 21 and second switching component 32 will not conduct at the same time during switching state of transformer 1. This overcomes the drawback of burning second switching component 32 if the first switching component 21 and second switching component were to be switched on together. Wherein the non-continuous mode operation, the cut-off signal could be sent out by first control circuit 22 when secondary current ID1 descends to zero. In other case, when the first switching circuit 22 did not send out a cut-off signal even if secondary current ID1 drop to zero, the invention sill use second control circuit 31 to control the resistance variation of second switching component 32. The resistance of second switching component 32 changes along with current outputted by transformer 1 and has an inverse proportional variation that makes second switching component 32 to enter cut-off state due to infinite resistance.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intending to be embraced within the scope of the invention as defined in the appended claims.

While the preferred embodiment of the invention has been illustrated and described, it will be appreciated that various changes can be made therein without departing from the spirit and scope of the invention.

1. A flyback type alternation power supply with primary/secondary synchronize control, which comprises of:
a transformer;
a primary switching unit comprising at least a first switching component and a first control circuit, wherein, the first switching component is connected to the primary side of the transformer; and the first control circuit controls the conduction states of the switching component;
a secondary switching unit comprising at least a second switching component, which is connect to the secondary side of the transformer; and
an insulating unit, which is connected in between the first control circuit and the second switching component;
wherein, the first control circuit controls the insulating unit to output a cut-off command signal to the second switching component for entering a cut-off state.

2. The flyback type alternation power supply in claim 1, wherein the first switching component is one of small signal controlled MOSFET (Metal Oxide Semi-conductor Field Effect Transistor) and thyristor.

3. The flyback type alternation power supply in claim 1, wherein the second switching component is one of small signal controlled MOSFET (Metal Oxide Semi-conductor Field Effect Transistor) and thyristor.

4. The flyback type alternation power supply in claim 1, wherein the insulating unit is one of a transformer and a light coupler.

5. A flyback type alternation power supply with primary/secondary synchronize control, which comprises of:
a transformer;
a primary switching unit comprising at least a first switching component and a first control circuit, wherein, the first switching component is collected to the primary side of the transformer; and the first control circuit controls the conduction states of the switching component;
a secondary switching unit comprising at least a second switching component and a second control circuit, wherein, the second switching component is connected to the secondary side of the transformer; and the second control circuit controls the conduction states of the second switching component; and
an insulating unit, which is connected in between the first control circuit and the second control circuit;
wherein, the first control circuit controls the insulating unit to output a cut-off signal to the second control circuit, which commands the second switching component to enter cut-off state after it receives a cut-off signal.

6. The flyback type alternation power supply in claim 5, wherein the first switching component is one small signal controlled MOSFET (Metal Oxide Semi-conductor Field Effect Transistor) and thyristor.

7. The flyback type alternation power supply in claim 5, wherein the first control circuit is a pulse-width modulation control IC.

8. The flyback type alternation power supply in claim 7, wherein the assigned number of the pulse-width modulation control IC is 3843, 3842 or 6841.

9. The flyback type alternation power supply in claim 5, wherein the second switching component is one of small signal controlled MOSFET (Metal Oxide Semi-conductor Field Effect Transistor) and thyristor.

10. The flyback type alternation power supply in claim 5, wherein the second control circuit comprises of:
a voltage level referencing circuit, which provides a voltage referencing level;
a buffer circuit, which outputs voltage for controlling resistance variation of the second switching component; and
a driving circuit, which adjusts the output voltage value of the buffer circuit base on the referencing voltage level; and keeps the voltage drop produced by the current flowing through the second switching component at a fixed voltage value; hence, allowing the resistance of the second switching component to vary inversely proportional along with output current of the transformer.

11. The flyback type alternation power supply in claim 5, wherein the insulating unit is one of a transformer and a light coupler.
